(19) United States
(12) Patent Application Publication
(10) Pub. No.: US 2009/0001789 A1
(43) Pub. Date: Jan. 1, 2009

(54) PANEL ASSEMBLY FOR A PASSENGER COMPARTMENT OF A VEHICLE

(75) Inventors: Steven G. Brown, Birmingham, MI (US); Timothy P. Parkin, Clarkston, MI (US); Jerome J. Ennis, Windsor (CA); Michael P. Fahey, Harrison Township, MI (US)

Correspondence Address: HOWARD & HOWARD ATTORNEYS, P.C., THE PINEHURST OFFICE CENTER, SUITE #101, 39400 WOODWARD AVENUE, BLOOMFIELD HILLS, MI, 48304-5151, US

(73) Assignee: BBI ENTERPRISES GROUP, INC., Bloomfield Hills, MI (US)

(21) Appl. No.: 12/164,380

(22) Filed: Jun. 30, 2008

Related U.S. Application Data
(60) Provisional application No. 60/937,688, filed on Jun. 29, 2007.

(51) Int. Cl. B60Q 3/02; B60N 2/00

(52) U.S. Cl. 297/217.6

(57) ABSTRACT

A panel assembly for a passenger compartment of a vehicle having passenger seating including a seat back is disclosed. A housing is mountable generally above the seat back within the passenger compartment. A light device is coupled to the housing and includes a first body portion and a second body portion being inelastic with the first body portion defining a first pivot axis. An illuminator is mounted to one of the body portions for selectively lighting a desired location over the passenger seating. A hinge is disposed between the body portions and spaced from the first pivot axis with the hinge defining a second pivot axis substantially parallel to the first pivot axis such that the second body portion rotates about the second pivot axis independently of rotation of the body portions about the first pivot axis for providing more accurate positioning of the illuminator to the desired location.

### CROSS REFERENCE TO RELATED APPLICATION

This application claims the benefit of U.S. Provisional Application Ser. No. 60/937,688 filed on Jun. 29, 2007, the advantages and disclosure of which are hereby incorporated by reference in its entirety.

### BACKGROUND OF THE INVENTION

1. Field of the Invention

The present invention generally relates to a panel assembly for a passenger compartment of a vehicle with the passenger compartment having passenger seating including a seat back with the assembly mounted generally above and behind the seat back, more specifically, a lighting apparatus for the passenger compartment of the vehicle.

2. Description of the Prior Art

Typically, vehicles are equipped with a light device or a dome light coupled to an overhead console of a passenger compartment. Having the light device coupled to the overhead console causes the entire passenger compartment to be illuminated when the light device is activated which is distracting to a driver of the vehicle and a driver of an approaching vehicle. For example, the light device will generally interfere with the driver's ability to see in the dark and the light device will create glare on a windshield, side windows and a rear window of the vehicle which reduces the driver's ability to see.

Other light devices are coupled to the overhead console and include an elongated arm having an illuminator on an end of the elongated arm. The elongated arm is flexible and movable between a storage position and a use position to position the illuminator closer to a passenger of the vehicle. The elongated arm allows a user to move the illuminator in the driver's direction thus still causing distraction issues. In addition, the elongated arm creates other distractions to the driver, such as blocking the driver's line of sight, children playing with the elongated arm as if the light device is a toy, the elongated arm is located in the driver's way for moving objects within the vehicle, etc. Further, the elongated arm cannot support itself in a generally horizontal direction because the entire elongated arm is flexible and the weight of the elongated arm will pull the arm downwardly.

Therefore, there still remains a need to have a panel assembly mounted generally above and behind a seat back of passenger seating with a lighting device moveable generally horizontally and limits an amount of illumination in a passenger compartment to minimize distractions to a driver and other passengers while providing aesthetics to the passenger compartment.

### SUMMARY OF THE INVENTION AND ADVANTAGES

The present invention provides for a panel assembly for a passenger compartment of a vehicle with the passenger compartment having passenger seating including a seat back with the assembly mounted generally above and behind the seat back. A housing is mountable generally above the seat back within the passenger compartment and a light device is coupled to the housing and includes a first body portion and a second body portion spaced from each other and being inelastic. The first body portion defines a first pivot axis such that the light device rotates about the first pivot axis between a storage position and a use position. An illuminator is mounted to one of the first and second body portions and movable between the storage and use positions for selectively lighting a desired location over the passenger seating. The light device includes a hinge disposed between the first and second body portions and spaced from the first pivot axis with the hinge defining a second pivot axis substantially parallel to the first pivot axis such that the second body portion rotates about the second pivot axis independently of rotation of the first and second body portions about the first pivot axis for providing more accurate positioning of the illuminator to the desired location.

The present invention also provides for a lighting apparatus for a passenger compartment of a vehicle with the passenger compartment having passenger seating including a seat back. A rear panel is mountable generally above and behind the seat back of the passenger seating with the rear panel defining an aperture. A housing is mounted in the aperture of the rear panel and disposed substantially flush to the rear panel. A light device is coupled to the housing and includes a first body portion and a second body portion spaced from each other and being inelastic. The first body portion defines a first pivot axis such that the light device rotates about the first pivot axis between a storage position and a use position. An illuminator is mounted to one of the first and second body portions and movable between the storage and use positions for selectively lighting a desired location over the passenger seating. A recess is defined by the housing and is complementary in configuration to the light device. The light device is disposed in the recess and is substantially flush to the housing when in the storage position with the first and second body portions rotatable about the first pivot axis outwardly away from the recess transverse to the first pivot axis when in the use position for lighting the desired location over the passenger seating.

The present invention further provides for a rear panel assembly for a passenger compartment of a vehicle having passenger seating with an accessible surface positioned rearward of the passenger seating and disposed inside the passenger compartment. A housing is secured to the accessible surface with a light device coupled to the housing. An illuminator is mounted to the light device with the light device being partially inelastic and pivotally affixed to the housing. The light device is pivotal in substantially a horizontal direction thereby spacing the illuminator from the housing for providing illumination to the passenger seating at a plurality of focused locations to limit an amount of illumination thereby restricting illumination to adjacent passenger seating.

The present invention therefore provides for a rear panel being mounted generally above and behind a seat back with a light device coupled to the rear panel which positions the light device farther away from a driver of a vehicle thus reducing illumination distractions. The light device includes a first body portion and a second body portion being inelastic such that the light device can support itself when the light device moves in substantially a horizontal direction which limits illumination to a generally downward direction thus reducing distractions to the driver and/or other passengers of the vehicle. In other words, having the light device move in the generally horizontal direction reduces distractions to the driver by focusing illumination of the light device toward the passenger seating and away from the driver. In addition, a hinge is disposed between the first and second body portions for providing more accurate positioning of an illuminator of the light device to a desired location thus satisfying the passenger's needs while preventing distractions to the driver and/or other passengers. Further, the rear panel, the housing and the light device are configured such that the rear panel, the housing and the light device are flush with each other for providing aesthetics to the vehicle and providing additional space within the vehicle.

### BRIEF DESCRIPTION OF THE DRAWINGS

Other advantages of the present invention will be readily appreciated, as the same becomes better understood by reference to the following detailed description when considered in connection with the accompanying drawings wherein:

FIG. 1 is a perspective view of a panel assembly and a lighting apparatus for a passenger compartment of a vehicle;

FIG. 2 is an exploded view of the panel assembly and the lighting apparatus;

FIG. 3 is a perspective view of a rear panel, a housing and a first light device and a second light device disposed flush to each other with the first and second light devices being in a storage position;

FIG. 4 is a perspective view of the first and second light devices in a use position with the first light device rotated about a first pivot axis and the second light device rotated about a third pivot axis and a fourth pivot axis;

FIG. 5 is a perspective view of the first light device having a plurality of first pins and first electrical wiring disposed therethrough and the second light device having a plurality of second pins and second electrical wiring disposed therethrough;

FIG. 6 is a perspective view of the first light device having a first body portion and a second body portion spaced from each other in the use position with the second body portion tilted relative to the first body portion in phantom lines;

FIG. 7 is a broken enlarged perspective view of the first light device and one wall of the housing taken from FIG. 6 with one of the first pins coupled to the wall and a first biasing member removed;

FIG. 8 is a broken enlarged perspective view of the first light device having a plurality of first securing members;

FIG. 9 is a broken enlarged perspective view of the second light device having a plurality of second securing members; and

FIG. 10 is a perspective view a second embodiment of a first light device and a second light device being selectively detachable from a housing.

### DETAILED DESCRIPTION OF THE INVENTION

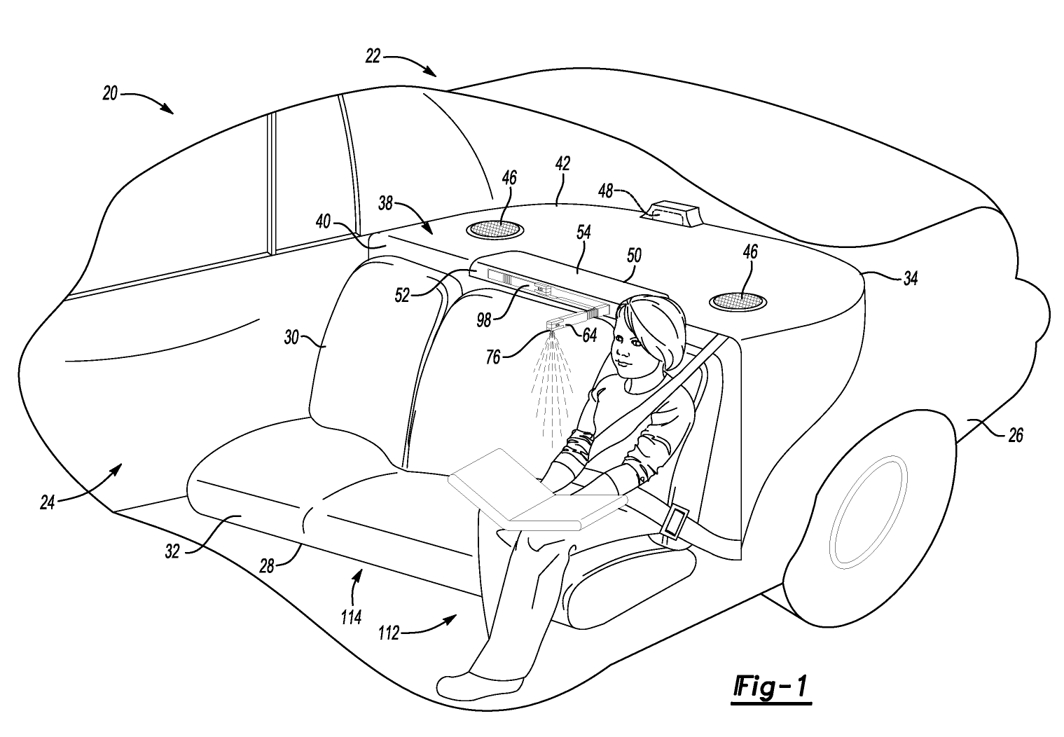

Referring to the Figures, wherein like numerals indicate like or corresponding parts throughout the several views, a panel assembly 20 and a lighting apparatus 22 for a passenger compartment 24 of a vehicle 26 is generally shown in FIGS. 1-3.

The passenger compartment 24 has passenger seating 28 including a seat back 30 extending generally vertically and a seat bottom 32 extending generally horizontally relative to the seat back 30. The light apparatus 22 includes the panel assembly 20, more specifically, a rear panel assembly 20, mounted generally above and behind the seat back 30.

The light apparatus 22 includes a rear panel 34 mountable generally above and behind the seat back 30 of the passenger seating 28 with the rear panel 34 defining an aperture 36. The rear panel 34 is attached to the vehicle 26 by any suitable methods known to those of ordinary skill in the art. The rear panel 34 may be formed from a fiber board, pressed cotton, glass, wood, flax filled, polypropylene, polymeric material or any other material or combination of materials. The rear panel 34 may be formed by any suitable methods known to those of ordinary skill in the art, such as molding methods including injection molding, blow molding, etc. The vehicle 26 may be a motor vehicle, a boat, a non-motorized vehicle or any other suitable vehicle where the rear panel 34 may be mounted generally above and behind the seat back 30.

The assembly 20 includes an accessible surface, generally indicated at 38, positioned rearward of the passenger seating 28 and disposed inside the passenger compartment 24 and more specifically, the accessible surface 38 is disposed on the rear panel 34. The accessible surface 38 includes a first segment 40 extending generally vertically above the passenger seating 28 and a second segment 42 extending generally horizontally relative to the first segment 40. The accessible surface 38 defines a plurality of orifices 44 for receiving a plurality of speakers 46 and a tail light 48 with the speakers 46 positioned between the passenger seating 28 and the tail light 48.

The assembly 20 includes a housing 50 mountable generally above the seat back 30 within the passenger compartment 24, typically the housing 50 is disposed centrally relative to the passenger seating 28. The housing 50 is secured to the accessible surface 38 of the rear panel 34 and is spaced from the orifices 44. More specifically, the housing 50 is disposed generally between the first and second segments 40, 42 of the accessible surface 38 above the passenger seating 28. The housing 50 may be formed from a fiber board, pressed cotton, glass, wood, flax filled, polypropylene, polymeric material or any other material or combination of materials. The housing 50 may be formed by any suitable methods known to those of ordinary skill in the art, such as molding methods including injection molding, blow molding, etc.

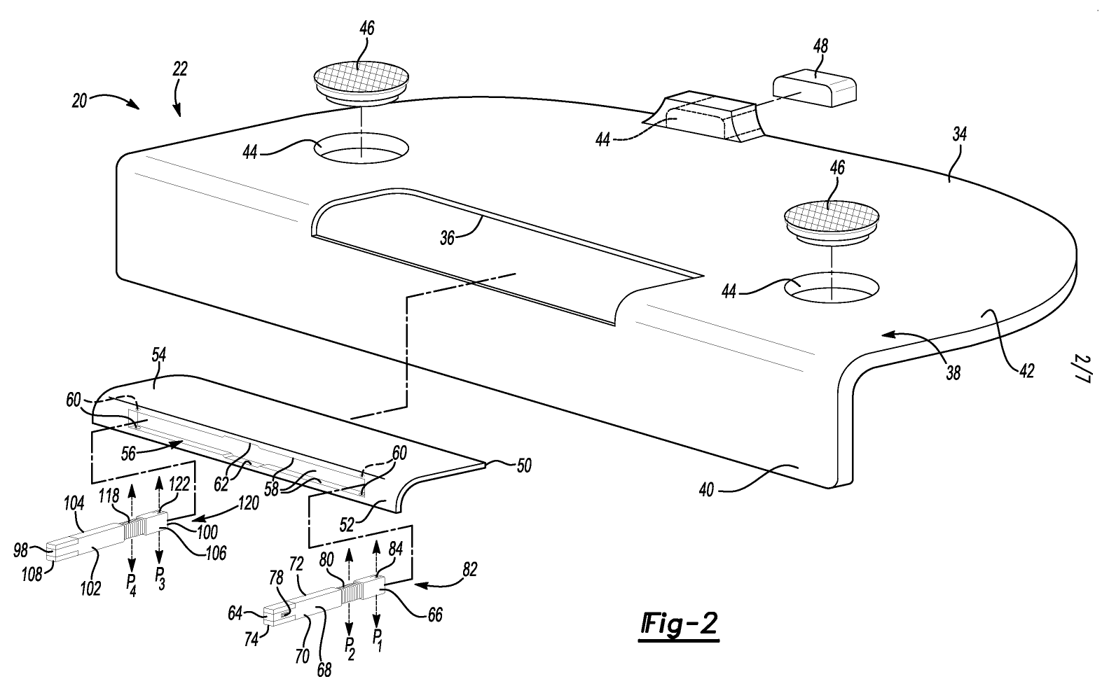

The housing 50 includes a vertical surface 52 generally flush with the first segment 40 and a horizontal surface 54 generally flush with the second segment 42. Typically, the housing 50 is mounted in the aperture 36 of the rear panel 34 and disposed substantially flush to the rear panel 34. As best shown in FIGS. 2 and 4, the housing 50 defines a recess generally indicated at 56, and more specifically, the vertical surface 52 of the housing 50 defines the recess 56. In other words, the housing 50 includes a plurality of walls 58 extending inwardly relative to the housing 50 to define the recess 56. A pair of the walls 58 define a plurality of bores 60 spaced from and substantially parallel to each other. A pair of walls 58 also define a depression 62 spaced from and substantially parallel to each other. The bores 60, the depression 62, the recess 56 and the walls 58 will be discussed further below.

The assembly 20 includes a light device 64 being partially inelastic and pivotally affixed to the housing 50. More specifically, the light device 64 is coupled to the housing 50 and includes a first body portion 66 and a second body portion 68 spaced from each other with the first and second body portions 66, 68 being inelastic. The recess 56 defined by the housing 50 is complementary in configuration to the light device 64 with the light device 64 disposed in the recess 56 and more specifically, the recess 56 is complementary in configuration to the first and second body portions 66, 68. The light device 64 is further defined as a first light device 64.

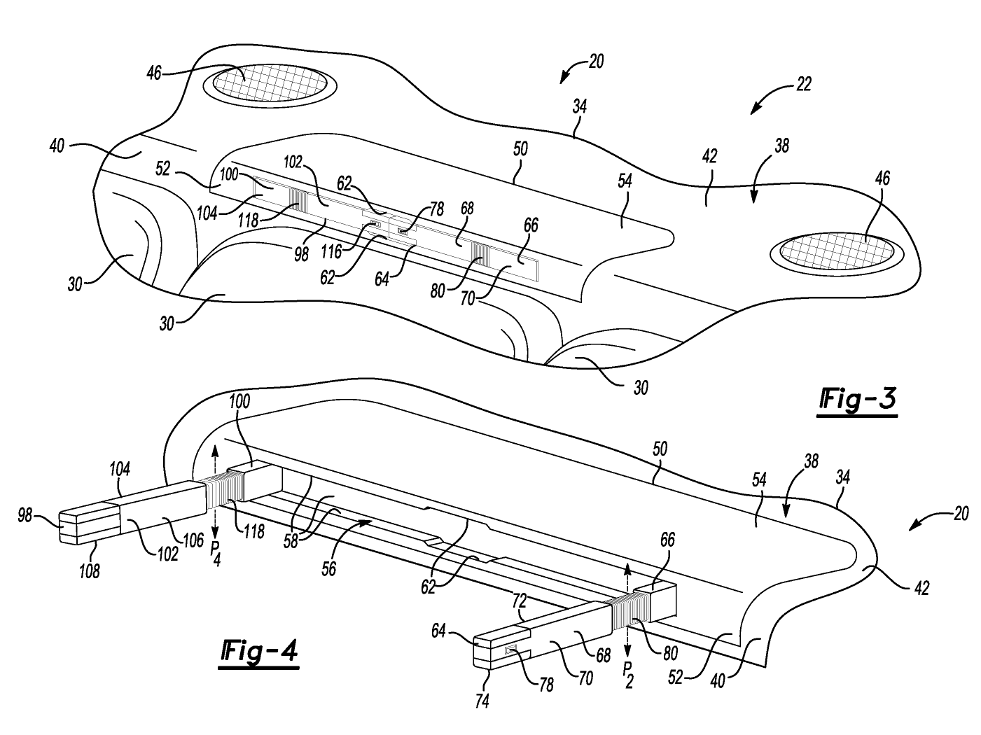

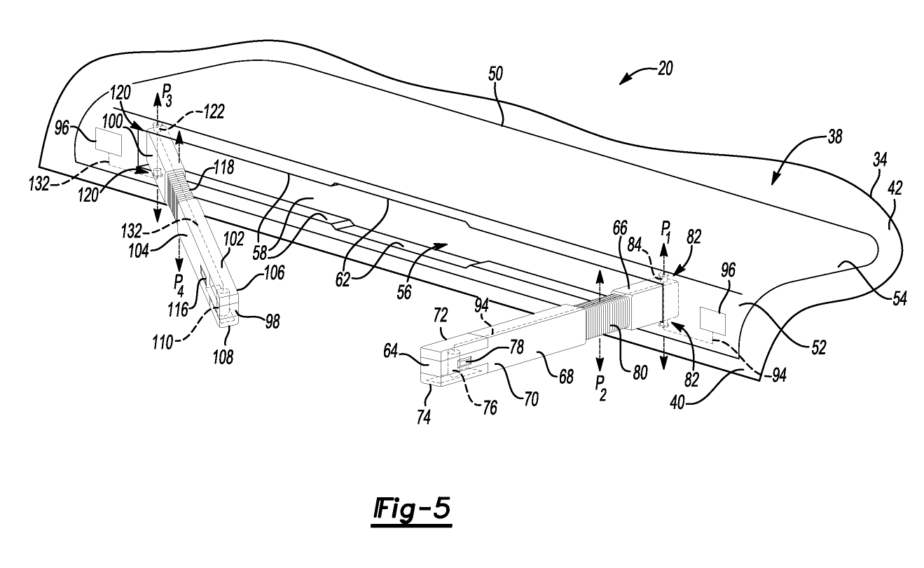

Also referring to FIG. 5, the first body portion 66 defines a first pivot axis P₁ such that the light device 64 rotates about the first pivot axis P₁ between a storage position and a use position. More specifically, the first and second body portions 66, 68 are rotatable about the first pivot axis P₁ outwardly away from the recess 56 transverse to the first pivot axis P₁ when in the use position for lighting a desired location over the passenger seating 28. The first and second body portions 66, 68 may be formed from any suitable material known to those of ordinary skill in the art, typically, materials having inelastic properties such that the first and second body portions 66, 68 move generally horizontally when in the use position. As shown in FIG. 4, when the light device 64 is in the use position, the light device 64 rotates outwardly away from the housing 50 transverse to the first pivot axis P₁ for allowing operation of the light device 64. As shown in FIG. 3, when the light device 64 is in the storage position, the light device 64 rotates toward the housing 50 and into the recess 56 for preventing operation of the light device 64. However it is to be appreciated that the light device 64 may be operated while in the recess 56 of the housing 50. The light device 64 is disposed in the recess 56 and substantially flush to the housing 50 when in the storage position. Having the light device 64 being substantially flush with the housing 50 provides aesthetics to the vehicle 26 and provides additional space within the passenger compartment 24. The depression 62 of the pair of walls 58 allows a passenger to grip the first light device 64 and rotate the first light device 64 from the storage position to the use position. It is to be appreciated that the pair of walls 58 may define a plurality of depressions 62, one of the walls 58 may define the depression 62 or one of the walls 58 may define the plurality of depressions 62.

The first and second body portions 66, 68 of the first light device 64 include a first front side 70 and a first back side 72 opposing each other with the first back side 72 facing one of the walls 58 and the first front side 70 disposed substantially flush to the housing 50 when in the storage position. More specifically, the first front side 70 is substantially flush with the vertical surface 52 of the housing 50. The first and second body portions 66, 68 also include a first bottom side 74 disposed between the first front side 70 and the first back side 72. The first bottom side 74 faces one of the walls 58 when in the storage position.

The assembly 20 further includes an illuminator 76 mounted to the light device 64 and more specifically, mounted to one of the first and second body portions 66, 68 and movable between the storage and use positions for selectively lighting the desired location over the passenger seating 28. Typically, the illuminator 76 is concealed in the recess 56 when in the storage position for preventing operation of the light device 64 and the illuminator 76 is spaced from the recess 56 when in the use position for allowing operation of the light device 64. The illuminator 76 may be further defined as at least one of fiber optics, light emitting diodes (LED), incandescent light bulbs or any other suitable illuminator known to those of ordinary skill in the art for lighting the desired location.

The illuminator 76 is further defined as a first illuminator 76 mounted to the second body portion 68 and more specifically, mounted within the second body portion 68. The first illuminator 76 illuminates generally downwardly through the first bottom side 74 of the first light device 64. The first illuminator 76 is selectively activated and deactivated for selectively lighting the desired location over the passenger seating 28. More specifically, a first switch 78 is mounted to one of the first and second body portions 66, 68 for selectively activating and deactivating the first illuminator 76 and more specifically, mounted to the second body portion 68. However it is to be appreciated that the first illuminator 76 and/or the first switch 78 may be mounted to the first light device 64 in other locations.

The light device 64 is pivotal in substantially a horizontal direction thereby spacing the illuminator 76 from the housing 50 for providing illumination to the passenger seating 28 at a plurality of focused locations to limit an amount of illumination thereby restricting illumination to adjacent passenger seating 28. In other words, having the light device 64 illuminate the passenger seating 28 at focused locations prevents distractions to a driver of the vehicle 26 and/or other passengers within the vehicle 26. When the light device 64 moves in substantially the horizontal direction, illumination is limited to a generally downward direction thus reducing distractions to the driver and/or other passengers of the vehicle 26.

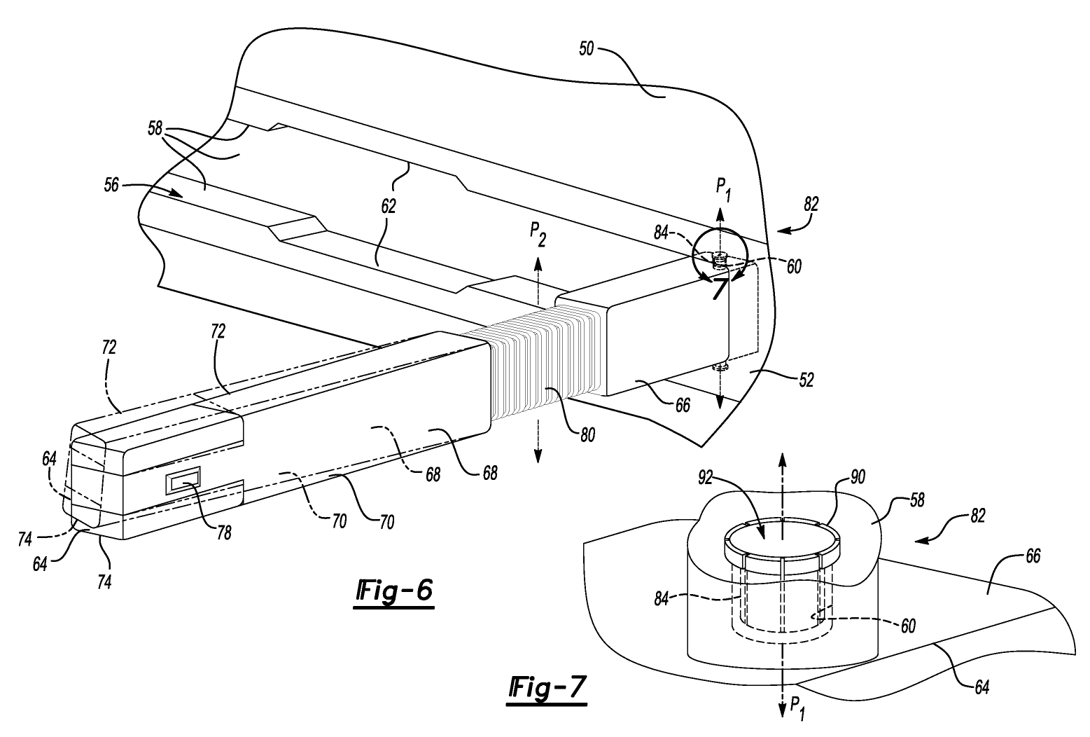

The light device 64 includes a hinge 80 spaced between the illuminator 76 and the housing 50 for providing additional degrees of illumination to the focused locations. More specifically, the hinge 80 is disposed between the first and second body portions 66, 68 and spaced from the first pivot axis P₁. The hinge 80 defines a second pivot axis P₂ substantially parallel to the first pivot axis P₁ such that the second body portion 68 rotates about the second pivot axis P₂ independently of rotation of the first and second body portions 66, 68 about the first pivot axis P₁ for providing more accurate positioning of the illuminator 76 to the desired location. Each of the first and second pivot axes P₁, P₂ extend generally vertically with the first body portion 66 rotating about the first pivot axis P₁ generally horizontally. The hinge 80 is flexible such that the second body portion 68 rotates about the second pivot axis P₂ generally horizontally relative to the second pivot axis P₂ such that the illuminator 76 is positioned forward of the seat back 30 when in the use position thereby satisfying the passenger's needs while preventing distractions to the driver and/or other passengers. As shown in phantom lines in FIG. 6, it is to be appreciated that the hinge 80 may allow the second body portion 68 to slightly tilt relative to the first body portion 66 for providing more accurate positioning of the illuminator 76. The tilting of the second body portion 68 is minimal to prevent distractions to the driver and/or other passengers of the vehicle 26. It is to be appreciated that the hinge 80 may be any suitable hinge known to those skilled in the art for allowing the second body portion 68 to rotate generally horizontally and tilt slightly. It is to be further appreciated that the hinge 80 may be formed from any suitable material known to those of ordinary skill in the art for allowing the second body portion 68 to rotate generally horizontally and tilt slightly. The hinge 80 is further defined as a first hinge 80 of the first light device 64.

Referring to FIGS. 5, 7 and 8 the first light device 64 further includes a plurality of first securing members, generally indicated at 82, mounted to the first body portion 66 for coupling the first light device 64 to the walls 58 within the recess 56 of the housing 50. The first securing members 82 are further defined as a plurality of first pins 84 mounted to the first body portion 66 and coupled to the walls 58. It is to be appreciated that the first securing members 82 may be any suitable securing members for coupling the first light device 64 to the walls 58 of the housing 50. The first pins 84 include a plurality of first ribs 86 extending about the first pins 84 and engage the walls 58 for rotating the first light device 64 at intervals between the use and storage positions. It is to be appreciated that the first securing members 82 may be any suitable securing members for coupling the first light device 64 to the walls 58 of the housing 50.

The first pins 84 also include a first biasing member 88 mounted to the first body portion 66 with the first pins 84 extending from the first biasing member 88. The first biasing member 88 biases the first pins 84 toward each other when inserting the first light device 64 into the recess 56 and biases the first pins 84 away from each other when aligning the first pins 84 with the bore 60 of the walls 58 to couple the first light device 64 to the housing 50. The first pins 84 further include a first flange 90 extending radially therefrom for coupling the first light device 64 to the housing 50. More specifically, the first pins 84 and the first flange 90 are inserted through the bore 60 of the walls 58 with the first flange 90 abutting the walls 58 after insertion for attaching the first light device 64 to the housing 50. It is to be appreciated that one first pin 84 and one first biasing member 88 may be used to attach the first light device 64 to the housing 50. The first pins 84 define a first passage, generally indicated at 92, disposed along the first pivot axis P₁ with first electrical wiring 94 disposed through the first passage 92 of the first pins 84. The first electrical wiring 94 is coupled to a power source 96 of the vehicle 26 and the first illuminator 76 for providing electricity to the first illuminator 76.

As best shown in FIGS. 2, 4 and 5, the assembly 20 includes a second light device 98 disposed adjacent the first light device 64 within the recess 56 of the housing 50. The second light device 98 defines a third pivot axis P₃ spaced from and generally parallel to the first pivot axis P₁ such that the second light device 98 rotates about the third pivot axis P₃ independently of the first light device 64 rotating about the first pivot axis P₁. In other words, the first and second light devices 64, 98 are each pivotally mounted to the housing 50 and spaced from each other such that the first light device 64 rotates independently of the second light device 98. The recess 56 defined by the housing 50 is complementary in configuration to both the first and second light devices 64, 98. It is to be appreciated that the first and second light devices 64, 98 are substantially similar in configuration to each other. It is to be further appreciated that the first and second light devices 64, 98 may be mirror images of each other. The rear panel 34, the housing 50, the first light device 64 and the second light device 98 are preassembled before being attached in the passenger compartment 24 of the vehicle 26. In other words, the rear panel 34, the housing 50, the first light device 64 and the second light device 98 are integrated into a single unit before being attached in the passenger compartment 24.

The second light device 98 includes a third body portion 100 and a fourth body portion 102 spaced from each other with the third and fourth body portions 100, 102 being inelastic. The recess 56 is complementary in configuration to the third and fourth body portions 100, 102. The third body portion 100 defines the third pivot axis P₃ with the second light device 98 rotatable about the third pivot axis P₃ between a storage position and a use position. More specifically, the third and fourth body portions 100, 102 are rotatable about the third pivot axis P₃ outwardly away from the recess 56 transverse to the third pivot axis P₃ when in the use position for lighting the desired location over the passenger seating 28. The third and fourth body portions 100, 102 may be formed from any suitable material known to those of ordinary skill in the art, typically, materials having inelastic properties such that the third and fourth body portions 100, 102 move generally horizontally when in the use position. As shown in FIG. 4, when the second light device 98 is in the use position, the second light device 98 rotates outwardly away from the housing 50 transverse to the third pivot axis P₃ for allowing operation of the second light device 98. As shown in FIG. 3, when the second light device 98 is in the storage position, the second light device 98 rotates toward the housing 50 and into the recess 56 transverse to the third pivot axis P₃ for preventing operation of the second light device 98. However it is to be appreciated that the second light device 98 may be operated while in the recess 56 of the housing 50. The second light device 98 is disposed in the recess 56 and substantially flush to the housing 50 and the first light device 64 when in the storage position. Having the first and second light devices 64, 98 being substantially flush with the housing 50 provides aesthetics to the vehicle 26 and provides additional space within the passenger compartment 24. The depression 62 of the pair of walls 58 allows the passenger to grip the second light device 98 and rotate the second light device 98 from the storage position to the use position. It is to be appreciated that the pair of walls 58 may define a plurality of depressions 62, one of the walls 58 may define the depression 62 or one of the walls 58 may define the plurality of depressions 62.

Referring back to FIGS. 4 and 5, the third and fourth body portions 100, 102 of the second light device 98 include a second front side 104 and a second back side 106 opposing each other with the second back side 106 facing one of the walls 58 and the second front side 104 disposed substantially flush to the housing 50 when in the storage position. More specifically, the second front side 104 is substantially flush with the vertical surface 52 of the housing 50 and the first front side 70 of the first light device 64. The third and fourth body portions 100, 102 also include a second bottom side 108 disposed between the second front side 104 and the second back side 106. The second bottom side 108 faces one of the walls 58 when in the storage position.

The second light device 98 includes a second illuminator 110 mounted to the fourth body portion 102 and more specifically, mounted within the fourth body portion 102. The second illuminator 110 illuminates generally downwardly through the second bottom side 108 of the second light device 98. Typically, the second illuminator 110 is concealed in the recess 56 when in the storage position for preventing operation of the second light device 98 and the second illuminator 110 is spaced from the recess 56 when in the use position for allowing operation of the second light device 98. In other words, the first and second illuminators 76, 110 of the first and second light devices 64, 98 face one of the walls 58 within the recess 56 when in the storage position for concealing the first and second illuminators 76, 110. The first and second illuminators 76, 110 rotate outwardly away from each other about the first pivot axis P₁ and the third pivot axis P₃ respectively when in the use position for positioning the first and second illuminators 76, 110 forward of the seat back 30. As shown in FIG. 1, the first light device 64 rotates outwardly toward a first section, generally shown at 112, of the passenger seating 28 when in the use position and the second light device 98 rotates outwardly toward a second section, generally shown at 114, of the passenger seating 28 adjacent to the first section 112 when in the use position.

The second illuminator 110 may be further defined as at least one of fiber optics, light emitting diodes (LED), incandescent light bulbs or any other suitable illuminator known to those of ordinary skill in the art for lighting the desired location. The second illuminator 110 is selectively activated and deactivated for selectively lighting the desired location over the passenger seating 28. More specifically as shown in FIGS. 3 and 5, a second switch 116 is mounted to one of the third and fourth body portions 100, 102 for selectively activating and deactivating the second illuminator 110. Typically, the second switch 116 is mounted to the fourth body portion 102 of the second light device 98. However it is to be appreciated that the second illuminator 110 and/or the second switch 116 may be mounted to the second light device 98 in other locations.

The second light device 98 includes a second hinge 118 disposed between the third and fourth body portions 100, 102 and spaced from the third pivot axis P₃. The second hinge 118 defines a fourth pivot axis P₄ substantially parallel to the third pivot axis P₃ such that the fourth body portion 102 rotates about the fourth pivot axis P₄ independently of rotation of the third and fourth body portions 100, 102 about the third pivot axis P₃ for providing more accurate positioning of the second illuminator 110 to the desired location. The second hinge 118 is flexible such that the fourth body portion 102 rotates about the fourth pivot axis P₄ generally horizontally relative to the fourth pivot axis P₄ such that the second illuminator 110 is positioned forward of the seat back 30 when in the use position. It is to be appreciated that the second hinge 118 may allow the fourth body portion 102 to slightly tilt relative to the third body portion 100 for providing more accurate positioning of the second illuminator 110. The tilting of the fourth body portion 102 is minimal to prevent distractions to the driver and/or other passengers of the vehicle 26. It is to be appreciated that the second hinge 118 may be any suitable hinge known to those skilled in the art for allowing the fourth body portion 102 to rotate generally horizontally and tilt slightly. It is to be further appreciated that the second hinge 118 may be formed from any suitable material known to those of ordinary skill in the art for allowing the fourth body portion 102 to rotate generally horizontally and tilt slightly.

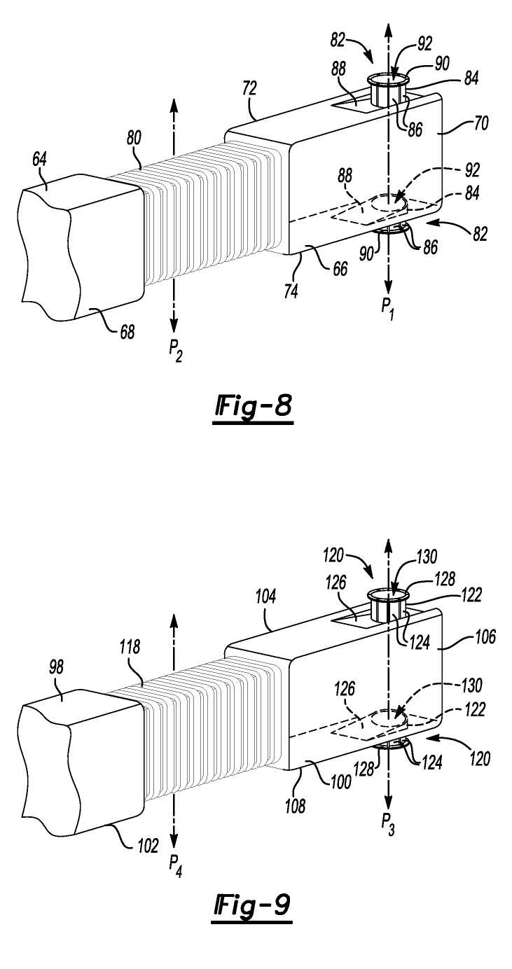

Also referring to FIG. 9, the second light device 98 includes a plurality of second securing members 120 mounted to the third body portion 100 for coupling the second light device 98 to the walls 58 within the recess 56 of the housing 50. The second securing members 120 are further defined as a plurality of second pins 122 mounted to the third body portion 100 and coupled to the walls 58. It is to be appreciated that the second securing members 120 may be any suitable securing members for coupling the second light device 98 to the walls 58 of the housing 50. The second pins 122 include a plurality of second ribs 124 extending about the second pins 122 and engage the walls 58 for rotating the second light device 98 at intervals between the use and storage positions. It is to be appreciated that the second securing members 120 may be any suitable securing members for coupling the second light device 98 to the walls 58 of the housing 50.

The second pins 122 also include a second biasing member 126 mounted to the third body portion 100 with the second pins 122 extending from the second biasing member 126. The second biasing member 126 biases the second pins 122 toward each other when inserting the second light device 98 into the recess 56 and biases the second pins 122 away from each other when aligning the second pins 122 with the bore 60 of the walls 58 to couple the second light device 98 to the housing 50. The second pins 122 further include a second flange 128 extending radially therefrom for coupling the second light device 98 to the housing 50. More specifically, the second pins 122 and the second flange 128 are inserted through the bore 60 of the walls 58 with the second flange 128 abutting the walls 58 after insertion for attaching the second light device 98 to the housing 50. It is to be appreciated that one second pin 122 and one second biasing member 126 may be used to attach the second light device 64 to the housing 50. The second pins 122 define a second passage, generally indicated at 130, disposed along the third pivot axis P₃ with second electrical wiring 132 disposed through the second passage 130 of the second pins 122. The second electrical wiring 132 is coupled to the power source 96 of the vehicle 26 and the second illuminator 110 for providing electricity to the second illuminator 110.

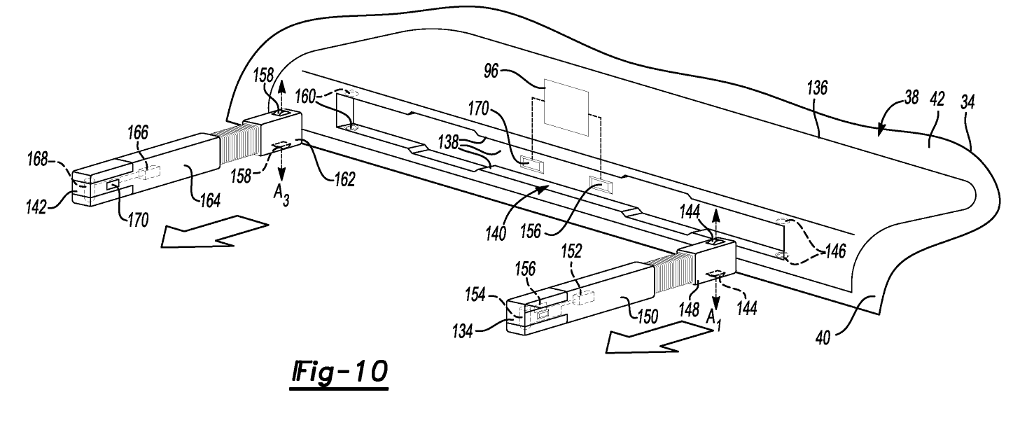

Referring to FIG. 10, a second embodiment of a light device 134 and a housing 136 is shown. Identical or similar components discussed in the first embodiment have the same reference numerals in this embodiment and additional or different components of this embodiment have different reference numerals. The primary distinction between this embodiment and the first embodiment is the light device 134 is selectively detachable from the housing 136 of the rear panel 34.

The housing 136 includes a plurality of walls 138 extending inwardly relative to the housing 136 to define a recess 140. The light device 134 is further defined as a first light device 134 and further includes a second light device 142 selectively removable from the recess 140 of the housing 136. More specifically, the first and second light devices 134, 142 are completely detachable from the housing 136 for allowing the passenger to utilize the first and second light devices 134, 142 in additional ways, such as for searching for items on a floor of the vehicle 26, etc.

The first and second light devices 134, 142 are substantially similar to each other thus allowing the first and second light devices 134, 142 to be interchangeable within the recess 140. Meaning, when the first light device 134 is removed from the recess 140, the second light device 142 may be inserted into the recess 140 where the first light device 134 was previously coupled to the housing 136. The first light device 134 defines a first pivot axis A₁ and the second light device 142 defines a third pivot axis A₃ spaced from the first pivot axis A₁ such that the first light device 134 rotates independently of the second light device 142. It is to be appreciated that the first and second light devices 134, 142 may be mirror images of each other. It is to be appreciated that the first and second light devices 134, 142 each include a hinge (not numbered) as described in the first embodiment.

One of the first light device 134 and the walls 138 includes a plurality of first locking members 144 and one of the first light device 134 and the walls 138 defines a plurality of first dimples 146 spaced from and substantially parallel to each other for selectively receiving the first locking members 144. The first locking members 144 and the first dimples 146 are disposed along the first pivot axis A₁ when the first light device 134 is locked into the housing 136. The first locking members 144 may bias for selectively locking and unlocking the first locking members 144 with the first dimples 146. However it is to be appreciated that the first locking members 144 may selectively lock into the first dimples 146 by any suitable methods known to those of ordinary skill in the art. The first locking members 144 may be defined as a tab, a fastener, a snap, a latch, a lock button or any other suitable locking members for selectively locking and unlocking the first light device 134 with the walls 138 of the housing 136. Typically, the first light device 134 includes the first locking members 144 and the walls 138 define the first dimples 146. The first locking members 144 and the first dimples 146 are configured to generally compliment each other such that the first locking members 144 engage the first dimples 146 thereby allowing the first light device 134 to rotate about the first pivot axis A₁ while remaining locked to the housing 136. It is to be appreciated that one first locking member 144 may be mounted to the first light device 134 and one of the walls 138 may define one first dimple 146.

One of a first body portion 148 and a second body portion 150 of the first light device 134 include a first battery source 152 for providing electricity to a first illuminator 154. Typically, the first battery source 152 is disposed within the second body portion 150 with the first battery source 152 coupled to the first illuminator 154. At least one of the walls 138 and one of the first and second body portions 148, 150 of the first light device 134 include a first electrical contact 156 for recharging the first battery source 152. Typically, one of the walls 138 and the second body portion 150 of the first light device 134 includes the first electrical contact 156. The first electrical contact 156 of one of the walls 138 is coupled to the power source 96 of the vehicle 26 and the first electrical contact 156 of the second body portion 150 is coupled to the first battery source 152. The first electrical contact 156 of one of the walls 138 abuts the first electrical contact 156 of the second body portion 150 for recharging the first battery source 152 when the first light device 134 is in the storage position.

One of the second light device 142 and the walls 138 includes a plurality of second locking members 158 and one of the second light device 142 and the walls 138 defines a plurality of second dimples 160 spaced from and substantially parallel to each other for selectively receiving the second locking members 158. The second locking members 158 and the second dimples 160 are disposed along the third pivot axis A₃ when the second light device 142 is locked into the housing 136. The second locking members 158 may bias for selectively locking and unlocking the second locking members 158 with the second dimples 160. However it is to be appreciated that the second locking members 158 may selectively lock into the second dimples 160 by any suitable methods known to those of ordinary skill in the art. The second locking members 158 may be defined as a tab, a fastener, a snap, a latch, a lock button or any other suitable locking members for selectively locking and unlocking the second light device 142 with the walls 138 of the housing 136. Typically, the second light device 142 includes the second locking members 158 and the walls 138 define the second dimples 160. The second locking members 158 and the second dimples 160 are configured to generally compliment each other such that the second locking members 158 engages the second dimples 160 thereby allowing the second light device 142 to rotate about the third pivot axis A₃ while remaining locked to the housing 136. It is to be appreciated that one second locking member 158 may be mounted to the second light device 142 and one of the walls 138 may define one second dimple 160.

One of a third body portion 162 and a fourth body portion 164 of the second light device 142 include a second battery source 166 for providing electricity to a second illuminator 168. Typically, the second battery source 166 is disposed within the fourth body portion 164 with the second battery source 166 coupled to the second illuminator 168. At least one of the walls 138 and one of the third and fourth body portions 162, 164 of the second light device 142 include a second electrical contact 170 for recharging the second battery source 166. Typically, one of the walls 138 and the fourth body portion 164 of the second light device 142 includes the second electrical contact 170. The second electrical contact 170 of one of the walls 138 is coupled to the power source 96 of the vehicle 26 and the second electrical contact 170 of the fourth body portion 164 is coupled to the second battery source 166. The second electrical contact 170 of one of the walls 138 abuts the second electrical contact 170 of the fourth body portion 164 for recharging the second battery source 166 when the second light device 142 is in the storage position. It is to be appreciated that having the first and second light devices 134, 142 being interchangeable, the first electrical contact 156 of the first light device 134 may abut the second electrical contact 170 of one of the walls 138 for recharging the first light device 134 and the second electrical contact 170 of the second light device 142 may abut the first electrical contact 156 of one of the walls for recharging the second light device 142. Further, the first locking members 144 of the first light device 134 may engage the second dimples 160 of the walls 138 for locking the first light device 134 to the housing 136 and the second locking members 158 of the second light device 142 may engage the first dimples 146 of the walls 138 for locking the second light device 142 to the housing 136.

Obviously, many modifications and variations of the present invention are possible in light of the above teachings. The foregoing invention has been described in accordance with the relevant legal standards; thus, the description is exemplary rather than limiting in nature. Variations and modifications to the disclosed embodiment may become apparent to those skilled in the art and do come within the scope of the invention. Accordingly, the scope of legal protection afforded this invention can only be determined by studying the following claims.

What is claimed is:

1. A panel assembly for a passenger compartment of a vehicle with the passenger compartment having passenger seating including a seat back with said assembly mounted generally above and behind the seat back, said assembly comprising:
a housing mountable generally above the seat back within the passenger compartment;
a light device coupled to said housing and including a first body portion and a second body portion spaced from each other and being inelastic with said first body portion defining a first pivot axis such that said light device rotates about said first pivot axis between a storage position and a use position;
an illuminator mounted to one of said first and second body portions and movable between said storage and use positions for selectively lighting a desired location over the passenger seating; and
said light device including a hinge disposed between said first and second body portions and spaced from said first pivot axis with said hinge defining a second pivot axis substantially parallel to said first pivot axis such that said second body portion rotates about said second pivot axis independently of rotation of said first and second body portions about said first pivot axis for providing more accurate positioning of said illuminator to said desired location.

2. An assembly as set forth in claim 1 wherein each of said first and second pivot axes extend generally vertically with said first body portion rotating about said first pivot axis generally horizontally and said hinge being flexible such that said second body portion rotates about said second pivot axis generally horizontally relative to said second pivot axis such that said illuminator is positioned forward of the seat back when in said use position.

3. An assembly as set forth in claim 2 wherein said housing includes a plurality of walls extending inwardly relative to said housing to define a recess complementary in configuration to said first and second body portions of said light device.

4. An assembly as set forth in claim 3 wherein said illuminator is concealed in said recess when in said storage position for preventing operation of said light device and said illuminator being spaced from said recess when in said use position.

5. An assembly as set forth in claim 3 wherein said light device is defined as a first light device and further includes a second light device disposed adjacent said first light device within said recess with said second light device defining a third pivot axis spaced from and generally parallel to said first pivot axis such that said second light device rotates about said third pivot axis independently of said first light device rotating about said first pivot axis.

6. An assembly as set forth in claim 5 wherein said second light device includes a third body portion and a fourth body portion spaced from each other and being inelastic with said third body portion defining said third pivot axis and said second light device rotatable about said third pivot axis between a storage position and a use position.

7. An assembly as set forth in claim 6 wherein said illuminator is further defined as a first illuminator mounted to said second body portion of said first light device and said second light device includes a second illuminator mounted to said fourth body portion with said first and second illuminators selectively activated and deactivated for selectively lighting said desired location over the passenger seating.

8. An assembly as set forth in claim 7 wherein said hinge is further defined as a first hinge of said first light device and said second light device includes a second hinge disposed between said third and fourth body portions and spaced from said third pivot axis with said second hinge defining a fourth pivot axis substantially parallel to said third pivot axis such that said fourth body portion rotates about said fourth pivot axis independently of rotation of said third and fourth body portions about said third pivot axis for providing more accurate positioning of said second illuminator to said desired location.

9. An assembly as set forth in claim 7 wherein said first and second illuminators of said first and second light devices face one of said walls within said recess when in said storage position for concealing said first and second illuminators with said first and second illuminators rotating outwardly away from each other about said first pivot axis and said third pivot axis respectively when in said use position for positioning said first and second illuminators forward of the seat back.

10. An assembly as set forth in claim 7 wherein said first light device includes a plurality of first securing members mounted to said first body portion for coupling said first light device to said walls within said recess of said housing.

11. An assembly as set forth in claim 10 wherein said first securing members are further defined as a plurality of first pins mounted to said first body portion and coupled to said walls with said first pins defining a first passage disposed along said first pivot axis.

12. An assembly as set forth in claim 11 further including a first electrical wiring disposed through said first passage of said first pins and coupled to said first illuminator for providing electricity to said first illuminator.

13. An assembly as set forth in claim 7 wherein said second light device includes a plurality of second securing members mounted to said third body portion for coupling said second light device to said walls within said recess of said housing.

14. An assembly as set forth in claim 13 wherein said second securing members are further defined as a plurality of second pins mounted to said third body portion and coupled to said walls with said second pins defining a second passage disposed along said third pivot axis.

15. An assembly as set forth in claim 14 further including a second electrical wiring disposed through said second passage of said second pins and coupled to said second illuminator for providing electricity to said second illuminator.

16. An assembly as set forth in claim 3 wherein said first and second light devices are selectively removable from said recess of said housing.

17. A lighting apparatus for a passenger compartment of a vehicle with the passenger compartment having passenger seating including a seat back, said apparatus comprising:
a rear panel mountable generally above and behind the seat back of the passenger seating with said rear panel defining an aperture;
a housing mounted in said aperture of said rear panel and disposed substantially flush to said rear panel;
a light device coupled to said housing and including a first body portion and a second body portion spaced from each other and being inelastic with said first body portion defining a first pivot axis such that said light device rotates about said first pivot axis between a storage position and a use position;
an illuminator mounted to one of said first and second body portions and movable between said storage and use positions for selectively lighting a desired location over the passenger seating; and
a recess defined by said housing and complementary in configuration to said light device with said light device disposed in said recess and being substantially flush to said housing when in said storage position with said first and second body portions rotatable about said first pivot axis outwardly away from said recess transverse to said first pivot axis when in said use position for lighting said desired location over the passenger seating.

18. An apparatus as set forth in claim 17 wherein said housing includes a plurality of walls extending inwardly relative to said housing to define said recess.

19. An apparatus as set forth in claim 18 wherein said illuminator is concealed in said recess when in said storage position for preventing operation of said light device and said illuminator being spaced from said recess when in said use position.

20. An apparatus as set forth in claim 18 wherein said a light device is further defined as a first light device and further includes a second light device disposed adjacent said first light device within said recess with said second light device defining a third pivot axis spaced from and generally parallel to said first pivot axis such that said second light device rotates about said third pivot axis independently of said first light device rotating about said first pivot axis.

21. An apparatus as set forth in claim 20 wherein said first and second body portions of said first light device include a first front side and a first back side opposing each other with said first back side facing one of said walls and said first front side disposed substantially flush to said housing when in said storage position.

22. An apparatus as set forth in claim 20 wherein said second light device includes a third body portion and a fourth body portion spaced from each other and being inelastic with said third body portion defining said third pivot axis with said second light device rotatable about said third pivot axis between a storage position and a use position.

23. An apparatus as set forth in claim 22 wherein said third and fourth body portions of said second light device include a second front side and a second back side opposing each other with said second back side facing one of said walls and said second front side disposed substantially flush to said housing when in said storage position.

24. An apparatus as set forth in claim 22 wherein said illuminator is further defined as a first illuminator mounted to said second body portion of said first light device and said second light device includes a second illuminator mounted to said fourth body portion with said first and second illuminators selectively activated and deactivated for selectively lighting said desired location over the passenger seating.

25. An apparatus as set forth in claim 24 wherein said first and second illuminators of said first and second light devices face one of said walls within said recess when in said storage position for concealing said first and second illuminators with said first and second illuminators rotating outwardly away from each other about said first pivot axis and said third pivot axis respectively when in said use position for positioning said first and second illuminators forward of the seat back.

26. An apparatus as set forth in claim 20 wherein said housing is disposed centrally relative to the passenger seating such that said first light device rotates outwardly toward a first section of the passenger seating when in said use position and said second light device rotates outwardly toward a second section of the passenger seating adjacent to said first section when in said use position.

27. An apparatus as set forth in claim 24 wherein said first light device including a first hinge disposed between said first and second body portions and spaced from said first pivot axis with said first hinge defining a second pivot axis substantially parallel to said first pivot axis such that said second body portion rotates about said second pivot axis independently of rotation of said first and second body portions about said first pivot axis for providing more accurate positioning of said first illuminator to said desired location.

28. An apparatus as set forth in claim 24 wherein said second light device includes a second hinge disposed between said third and fourth body portions and spaced from said third pivot axis with said second hinge defining a fourth pivot axis substantially parallel to said third pivot axis such that said fourth body portion rotates about said fourth pivot axis independently of rotation of said third and fourth body portions about said third pivot axis for providing more accurate positioning of said second illuminator to said desired location.

29. An apparatus as set forth in claim 20 wherein said rear panel, said housing, said first and second light devices are preassembled before being attached in the passenger compartment.

30. A rear panel assembly for a passenger compartment of a vehicle having passenger seating, comprising:
an accessible surface positioned rearward of the passenger seating and disposed inside the passenger compartment;
a housing secured to said accessible surface;
a light device coupled to said housing;
an illuminator mounted to said light device; and
said light device being partially inelastic and pivotally affixed to said housing and being pivotal in substantially a horizontal direction thereby spacing said illuminator from said housing for providing illumination to the passenger seating at a plurality of focused locations to limit an amount of illumination thereby restricting illumination to adjacent passenger seating.

31. An assembly as set forth in claim 30 wherein said accessible surface includes a first segment extending generally vertically above the passenger seating and a second segment extending generally horizontally relative to said first segment.

32. An assembly as set forth in claim 31 wherein said housing is disposed generally between said first and second segments above the passenger seating and includes a vertical surface generally flush with said first segment and a horizontal surface generally flush with said second segment.

33. An assembly as set forth in claim 32 wherein said vertical surface of said housing defines a recess complementary in configuration to said light device with said light device disposed in said recess and being substantially flush to said housing when in said storage position.

34. An assembly as set forth in claim 30 wherein said light device includes a hinge spaced between said illuminator and said housing for providing additional degrees of illumination to said focused locations.

35. An assembly as set forth in claim 30 wherein said illuminator is further defined as fiber optics.

36. An assembly as set forth in claim 30 wherein said illuminator is further defined as light emitting diodes.

37. An assembly as set forth in claim 30 wherein said illuminator is further defined as incandescent light bulbs.

38. An assembly as set forth in claim 30 wherein said light device is further defined as a first light device and further includes a second light device each pivotally mounted to said housing and spaced from each other such that said first light device rotates independently of said second light device.

39. An assembly as set forth in claim 30 wherein said accessible surface defines a plurality of orifices spaced from said housing for receiving a plurality of speakers.
